(19) United States
(12) Patent Application Publication
(10) Pub. No.: US 2019/0389750 A1
(43) Pub. Date: Dec. 26, 2019

(54) ON-LINE AND CONTINUOUS MEASUREMENT OF ORGANIC CARBON IN PETROLEUM REFINERY DESALTER BRINE WATER TO MONITOR, CONTROL AND OPTIMIZE THE DESALTER PROCESS UNIT

(71) Applicant: GENERAL ELECTRIC COMPANY, Schenectady, NY (US)

(72) Inventors: Luise GUY, Brights Grove (CA); Michael ODORICO, Brights Grove (CA); John PASTERCZYK, Boulder, CO (US); Mark Norman KNIGHT, Toronto (CA); David MASON, The Woodlands, TX (US)

(21) Appl. No.: 16/464,821

(22) PCT Filed: Jul. 19, 2017
(86) PCT No.: PCT/US2017/042873

§ 371 Date: May 29, 2019

Related U.S. Application Data
(60) Provisional application No. 62/428,649, filed on Dec. 1, 2016.

(51) Int. Cl. C02F 1/52; C02F 1/24

(52) U.S. Cl. CPC C02F 1/5209; C02F 1/24; C02F 2103/365; C02F 2209/20; C02F 1/5245

(57) ABSTRACT

Disclosed herein are systems and methods method of treating wastewater. The method comprises measuring total organic carbons (TOC) in a stream of wastewater (202) from a processing plant (204), wherein the TOCs are measured in the stream of wastewater (202), providing the measured TOC's to a processing device (210), determining, based on the measured TOCs in the stream of wastewater (202), a treatment protocol for the stream of wastewater (202), and treating the wastewater stream (202) by controlling a feed control unit (212) in accordance with the determined treatment protocol.

### CROSS REFERENCE TO RELATED APPLICATION

This application claims priority to and benefit of U.S. Provisional Patent Application Ser. No. 62/428,649 filed Dec. 1, 2016, which is fully incorporated by reference and made a part hereof.

### BACKGROUND

Unconventional crude oil development has brought about a new era for refineries while reliability, sustainability and profitability remain key business drivers. As crude slates rapidly change and production grows, the influence of rising costs, volatile markets, increasing water scarcity, and mechanical and operational complexities intertwine with ever more stringent environmental regulation. The end result is operational uncertainty.

It is increasingly more important for refiners to be able to identify, interpret and respond quickly to changes in crude feed properties. Today's refiners are continually adapting to increasing variability in crude oil quality. Couple this with the blending of tight oils into the standard crude slate, and normal refinery operations can be difficult to maintain. Processing the difficult blends has a significant negative impact on overall profitability, affecting product quality, unit reliability and on-stream time.

Tight or shale oils are considered opportunity crudes because they are typically less expensive than crudes produced by traditional drilling methods. Processing these cheaper crudes offers today's refiners obvious economic incentives, but they come with their own set of unique challenges. Although tight and shale oils are not technically the same (shale oil is actually a subset of tight oil).

Tight oils account for much of the growth in US oil production. This trend is expected to continue for many years, as well as expand globally.

The term ‘tight oil’ is derived from the fact that the oil and gas deposits are tightly held within geological formations and are not free-flowing, as the rock is very dense and not porous. The techniques used to extract tight oil supplies often result in the oil containing more production chemicals and increased solids with smaller particle size than conventional crudes. When introduced to the refining process, tight oils can stabilize emulsions in the desalter, increase the potential for system corrosion and fouling, as well as negatively impact wastewater treatment.

Tight oils have many physical properties in common, but the characteristics that differentiate them from one another are, in many cases, the root cause of a variety of processing challenges. Common tight oil characteristics can include: Batch to batch variability, even within the same type of crude oil supply; Gravity ranges 20-55° API; Low sulfur levels, but H₂S can be an issue; Low levels of nitrogen; High paraffin content; Heavy metals (Ni & V) are low; Level of alkaline metals (Ca, Ma, Mg) can be high; Other contaminants (Ba, Pb) may be present; Filterable solids: greater volume and smaller size; Contain olefins and carbonyls that are fouling precursors that are not typically found in virgin crude oils; and Production chemicals or contaminants.

Determining how a new crude oil fits into a refinery operation requires a comprehensive understanding of physical properties and unique characteristics of the crude and how it will interact with the rest of the typical crude slate.

The wastewater treatment plant may experience operational difficulties when blending tight oils into the supply. High levels of solids and smaller particles size may challenge the primary wastewater treatment process, which may require a redesign or change in the chemical program. Increased levels of chemical oxygen demand (COD), biochemical oxygen demand (BOD) and nitrogen load into the wastewater plant form contaminants removed in the desalter, such as solids, other contaminants and the H₂S scavengers that are fed upstream can place an additional load on the biological system. Also the presence of some heavy metals carbons may compromise discharge limits.

One of the treatment objectives of primary treatment device in a HPI or CPI plant is to remove oil and grease and oily solids from the wastewater before the biological or secondary treatment system. Generally, coagulants and flocculants are added to the influent of a flotation device to facilitate the removal of free and emulsified oils and oily solids from the wastewater in primary treatment. Conventionally, visual observation, turbidity and total suspended solids (TSS) measurements are used to control the chemical dosage. However, by measuring the constituent concentration, specifically organic carbon, in the brine as it enters the wastewater treatment system, at the primary treatment device, along with proprietary control algorithms, an automated system for the management and control of chemical dosing in the floatation system can be achieved that optimizes chemical dosing, minimizes whole effluent toxicity caused by recalcitrant and toxic organic carbons, and stabilizes the organic loading and process performance of downstream treatment processes.

Furthermore, a petroleum refinery typically processes a variety of crude oils and recycled slop oils. These oils contain a variety of contaminants that would cause significant fouling and corrosion in downstream refinery units. To mitigate this fouling and corrosion, the crude oil has process chemicals added to it as well as being washed using a variety of water sources. This step transfers solid particles and salts from the hydrocarbon to the water phase. The combined oil-water mixture is then allowed to separate in the desalter unit. The washed crude oil is then sent to be further processed in the refinery. The generated desalter brine water is sent to the wastewater treatment plant (WWTP) to be further processed. Petroleum refinery desalter brine contains a significant concentration of organic and inorganic compounds including but is not limited to free phase hydrocarbons, emulsified hydrocarbons, solid particles, amines and chlorides. These compounds plug up conventional total organic carbons (TOC) analyzers making on-line and continuous monitoring very difficult and unreliable. Therefore, the desalter brine is typically monitored by operations staff by a visual check or by bench scale lab tests. The quality and composition of the desalter brine then indicates how the upstream process chemistry needs to be adjusted to optimize the desalter unit.

Therefore, what is desired are systems, methods, devices, and computer program products that overcome challenges in the art, some of which are described above, for treating wastewater based on organics.

### SUMMARY

Disclosed herein systems, methods, devices, and computer program products for treating wastewater based on measurements of organics (e.g., total organic carbons (TOCs), dissolved organic carbons (DOCs)) in the wastewater stream. Wastewater is sampled at one or more locations in the wastewater stream, analyzed for organics carbons and the measured organics are used by a processing device to automatically control chemical dosage of the wastewater stream based on feed-forward, feedback or combined feed-forward and -back signals. Conventionally, visual observation, turbidity and TSS measurements have been used in either manual and sometimes in an automated mode for determining chemical dosing of wastewater. Measuring organics provides a measurement of the removal efficiency of the primary treatment, more importantly a direct measurement of the dissolved organics, which may include oil and grease, amines, COD (chemical oxygen demand), dissolved organics and potentially toxic organic carbons that can interfere with the biological treatment process or pass through the plant and exert potentially acute toxicity on the aquatic organisms that may be attributable to recalcitrant COD, naphthenic acids, and other carbons.

Described herein is a method of treating wastewater comprising measuring, using an analyzer, at least total organic carbons (TOCs) in a stream of wastewater comprised of petroleum refinery desalter brine water; providing, by the analyzer, the measured TOCs to a processing device; determining, by the processing device, based on the measured TOCs in the stream of wastewater, a treatment protocol for the stream of wastewater; and treating the wastewater stream by controlling, by the processing device, a feed control unit in accordance with the determined treatment protocol.

In another aspect, systems for treating wastewater are disclosed. One such system is comprised of a desalter; an analyzer, wherein the analyzer measures at least total organic carbons (TOC) in a stream of wastewater comprised of petroleum refinery desalter brine water; and a processing device in communication with the analyzer and a feed control unit, wherein the processing device: receives the measured TOCs from the analyzer; determines, based on the measured TOCs in the stream of wastewater, a treatment protocol for the stream of wastewater; and treats the wastewater stream by controlling the feed control unit in accordance with the determined treatment protocol.

In yet another aspect, a method of treating wastewater using a total organic carbon (TOC) analyzer is disclosed. The method comprises receiving, by the TOC analyzer, a sample of a stream of wastewater from a processing plant, wherein the wastewater is comprised of petroleum refinery desalter brine water; measuring, by the TOC analyzer, at least TOCs in the stream of wastewater from the processing plant as determined by the sample; and providing, by the analyzer, the measured TOC's to a processing device, wherein based on the measured TOCs in the stream of wastewater, the processing device executes a treatment protocol for the stream of wastewater comprising controlling a feed control unit in accordance with the determined treatment protocol.

Also disclosed herein is a non-transitory computer program product comprising computer-executable code sections for executing by a processor, said computer-executable code sections causing the processor to: receive, from an analyzer, measured TOCs for a wastewater stream comprised of petroleum refinery desalter brine water; determine, based on the measured TOCs in the stream of wastewater, a treatment protocol for the stream of wastewater; and treat the wastewater stream by controlling a feed control unit in accordance with the determined treatment protocol.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a high-level illustration of a typical processing plant's wastewater system;

FIG. 2A is an exemplary illustration of a system for treating wastewater;

FIG. 2B is an exemplary illustration of another system for treating wastewater;

FIG. 2C is an exemplary illustration of another system for treating wastewater;

FIG. 2D is an exemplary illustration of yet another system for treating wastewater;

FIG. 3 is a flowchart that illustrates an exemplary method for treating wastewater;

FIG. 4 illustrates an exemplary processing that can be used for controlling aspects of the disclosure; and

FIG. 5 is a block schematic diagram of a desalter system that can be used in a refining process, in accordance with some embodiments.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

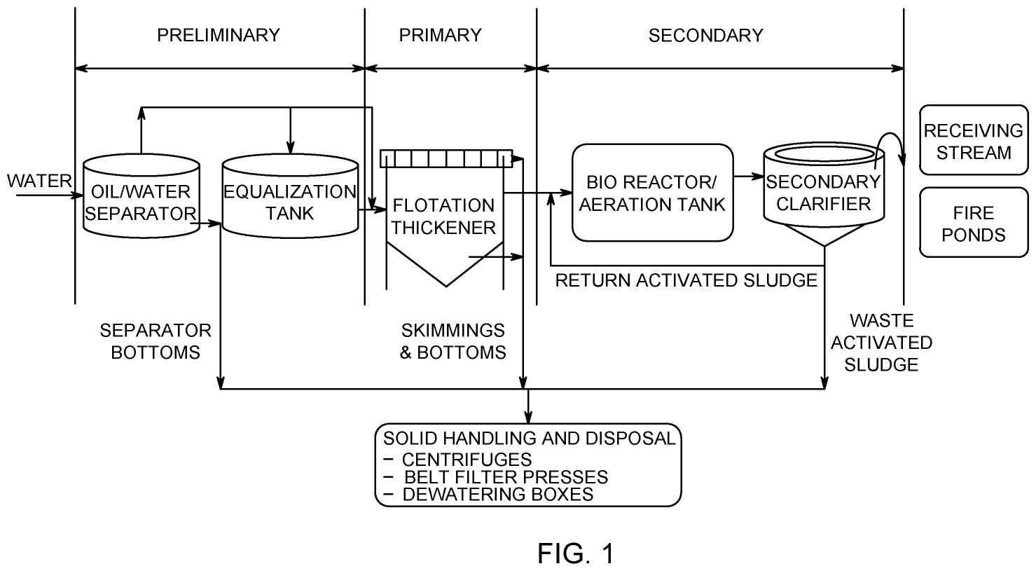

FIG. 1 is a high-level illustration of a typical processing plant's wastewater system. As shown in FIG. 1, a typical system is comprised of three stages—a preliminary stage, a primary stage and a secondary stage. Generally, the preliminary stage receives the raw wastewater and performs some preliminary treatment using devices such as an oil/water separator, an equalization tank, and the like. The primary stage receives the preliminarily treated wastewater from the primary stage and performs the steps of removing organic floaters and sinkers from the wastewater stream. Generally, this is done using a device such as a flotation thickener. Various flotation thickeners include dissolved air flotation (DAF) thickener, dissolved nitrogen flotation (DNF) thickeners, dissolved gas flotation (DGF) thickeners, induced air flotation (IAF) thickeners, induced nitrogen flotation (INF) thickeners, induced gas flotation (IGF) thickeners, entrapped or entrained gas flotation (EGF) thickeners, and the like. General objectives of the primary stage are to remove approximately 90% of the readily settleable suspended solids (TSS) and oil & grease; remove approximately 40-65% of the total suspended solids, TSS (filterable residue); and remove approximately 25-35% of the biodegradable organics. Performance of the primary stage can be greatly enhanced performance with chemicals, resulting in up to approximately 85-90% removal of the organic suspended solids.

The secondary processing stage includes downstream processing from the primary stage. As shown, such downstream processing can involve the use of a bioreactor/aeration tank, a secondary clarifier, and the like. Final disposition of the wastewater stream after treatment can be to, for example, a receiving stream and/or a fire pond.

The focus of this disclosure will generally be on the primary stage of wastewater treatment.

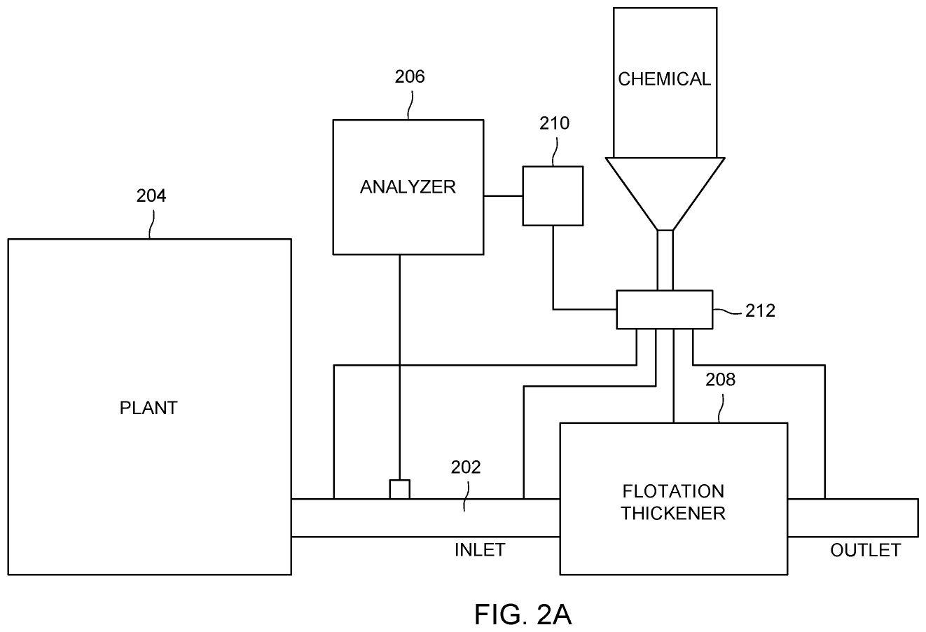

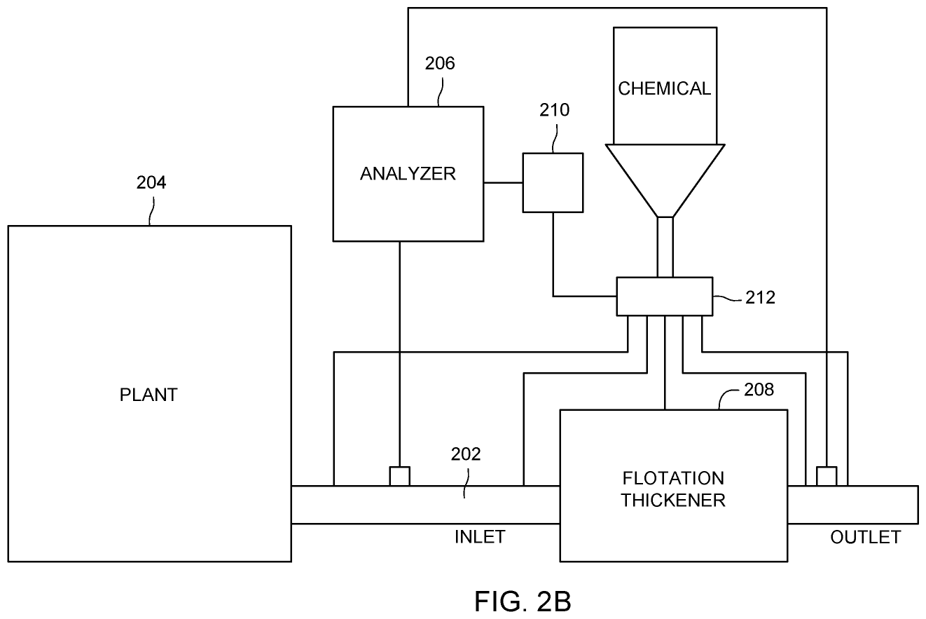

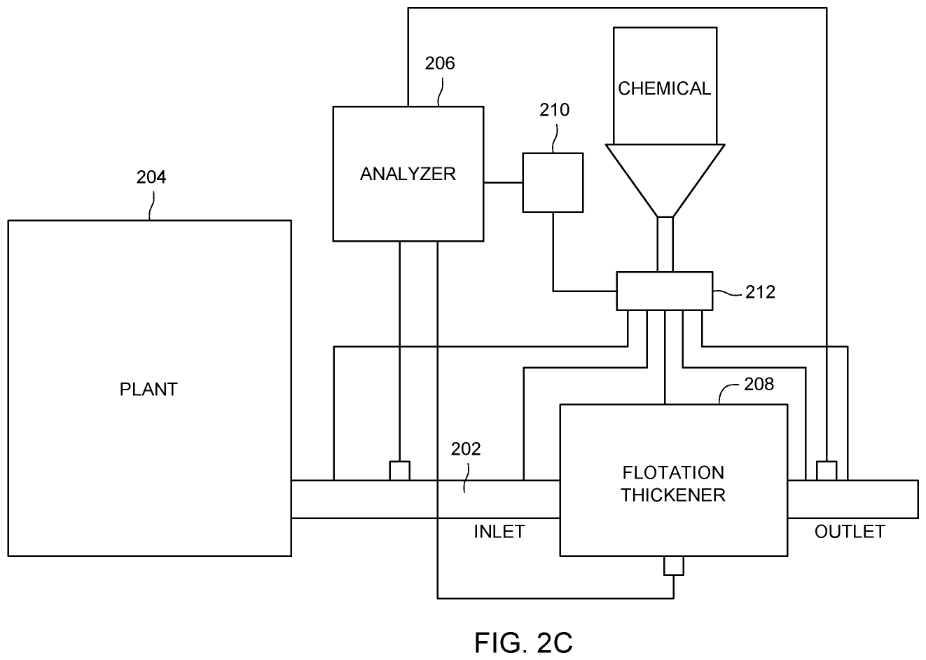

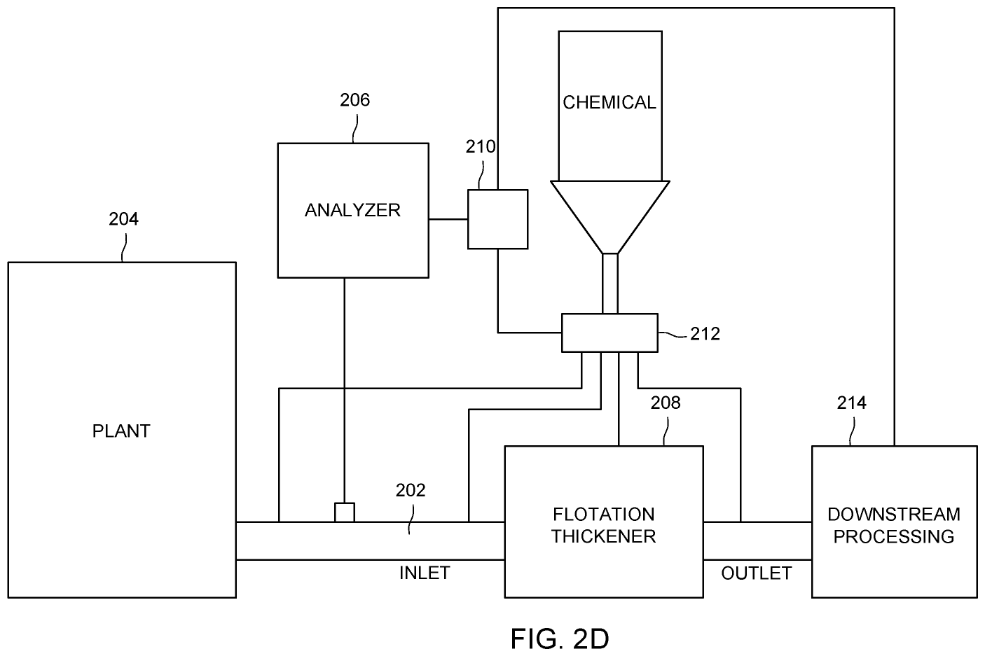

FIG. 2A is an exemplary illustration of a system for treating wastewater. As shown in FIG. 2A, a wastewater stream 202 flows from a processing plant 204. The processing plant 204 may include but not be limited to a hydrocarbon processing industry (HPI) plant (i.e., a refinery), a chemical processing industry (CPI) plant, a primary metals (PM) plant, a food and beverage (F&B) plant, a power plant, and the like. Generally, the wastewater stream 202 is contaminated by the plant 204. Sources of contaminants in the wastewater stream can include, for example, process water that has had intimate contact with hydrocarbons. Such process water may include desalter effluent, sour water, tank bottom draws, spent caustic, and the like. Other sources of contaminants can include boiler feedwater (BFW) blowdown, cooling tower blowdown, released cooling water, and the like. Typical wastewater contaminant concentrations can include free hydrocarbons (up to 1000 mg/L), chemical oxygen demand (COD) (400 to 1000 mg/L), suspended solids (up to 500 mg/L), phenols (10 to 100 mg/L), benzene (5 to 15 mg/L), sulfides (up to 100 mg/L), ammonia (up to 100 mg/L), and the like.

Returning to FIG. 2A, an analyzer 206 is used to measure organics in the wastewater stream 202. In one non-limiting example, the analyzer 206 comprises a GE InnovOx™ TOC analyzer (General Electric Company, Schenectady, N.Y.). It is to be appreciated; however, that other analyzers may be used. Generally, organics are measured after the wastewater 202 has undergone preliminary treatment, but measurement not limited to after preliminary treatment. Measuring organics in the wastewater stream 202 is advantageous because it can provide early detection of trouble with upstream treatment processes; many times conditions go undetected until troubles are encountered in downstream treatment processes; organics are the food for the microorganisms in the bioplant; most often organics are blamed for bio plant upsets; some organics are toxic to the biological wastewater treatment system, while others may pass through the wastewater treatment system untreated and may be toxic to aquatic organisms; and the like. Removal of a large portion of organic solids is accomplished in the flotation thickener 208. Removal of organics is greatly increased by properly dosing chemicals such as coagulants and flocculants in the primary stage of wastewater treatment.

Conventionally, organics are measured by BOD, COD and TOC. Generally, an analyzer 206 can measure TOC in less than 10 minutes. TOC provides a direct measurement of organic carbon in the wastewater stream 202. TOC is the amount of carbon bound in organic compounds, and includes non-purgeable organic carbon (the amount of organic carbon remaining in an acidified sample after purging with inert gas); purgeable organic carbon (carbon removed in an acidified sample by purging with an inert gas (VOC that can be removed by gas stripping include—benzene, toluene, cyclohexane, and chloroform)); dissolved organic carbon (organic carbon after filtering with 0.45μ filter); and suspended organic carbon (particulate organic carbon form that is too large to pass through a 0.45μ filter). TOC does not include inorganic carbon (carbonate, bicarbonate and dissolved carbon dioxide).

As shown in FIG. 2A, TOCs in the wastewater stream 202 can be measured on a continuous basis using the analyzer 206. In the embodiment shown in FIG. 2A, TOCs are measured in the stream of wastewater 202 at an inlet to the flotation thickener 208. The process objective of the flotation thickener 208 is to remove any free oil carryover from an oil/water separator and the organic suspended solids (TSS) and dissolved organics that can be removed by adding chemicals such as coagulants and flocculants. These contaminants are removed as the float on the flotation thickener 208 or as settled sludge, or bottoms, in the oil/water separator.

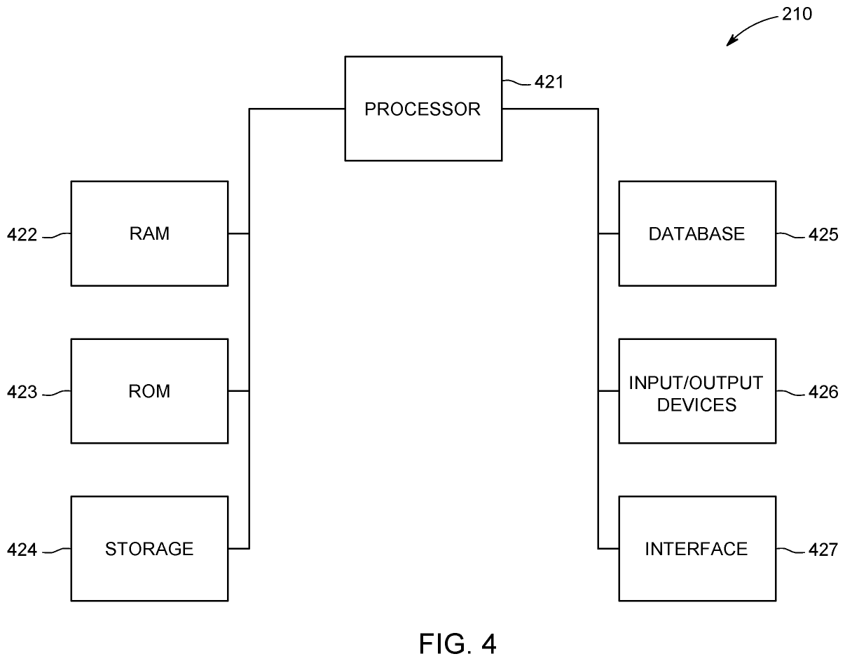

The TOCs in the wastewater stream 202, as measured by the analyzer 206, can be provided to a processing device 210. The processing device 210 may be integrated with and into the analyzer 206, or it may be separate from the TOC analyzer 206. For example, the processing device 210 may be a portion of a control system and may comprise a programmable logic controller (PLC), a computer, distributed control system (DCS), a field-programmable gate array (FPGA), and the like. In one aspect, the processing device 210 may comprise a plurality of processors that are in communication with one another. For example, the processor of the analyzer 206 may be in communication with the processor of a control system. As used herein, processing device 210 refers to a physical hardware device that executes encoded instructions for performing functions on inputs and creating outputs. Exemplary processing devices 210 for use in this disclosure are described herein in relation to FIG. 4. The processing device 210 can be used to determine a treatment protocol for the stream of wastewater 202 based on the measured TOCs in the stream of wastewater 202. For example, the processing device 210 can execute an algorithm in a feed forward/feedback control strategy to automatically adjust a chemical feed of a feed control unit 212 to the wastewater stream 202 to ensure continuous effective chemical dosing in accordance with the determined treatment protocol.

Though FIG.2A illustrates the analyzer measuring TOCs only at the inlet to the flotation thickener 208, it is to be appreciated that TOCs may be measured at other locations in the wastewater stream 202. For example, as shown in FIG. 2B, TOCs can be measured by the analyzer 206 at an outlet of the flotation thickener 208, wherein the measured TOCS provided to the processing device 210 includes the TOCs measured at the inlet of the flotation thickener and the TOCs measured at the outlet of the flotation thickener. Similarly, referring to FIG. 2C, TOCs can be measured by the analyzer 206 in the flotation thickener 208, wherein the measured TOCs provided to the processing device 210 includes one or more of the TOCs measured at the inlet of the flotation thickener 208, the TOCs measured at the outlet of the flotation thickener 208, and the TOCs measured in the flotation thickener 208. Also in FIG. 2C it is shown that chemicals can be added either before and/or after the TOC measurement point at the outlet of the flotation thickener 208.

Referring back to FIG. 2A, treating the wastewater stream 202 by controlling, by the processing device 210, the feed control unit 212 in accordance with the determined treatment protocol comprises the feed control unit 212 adding chemicals to the stream of wastewater 202. The added chemicals may comprise one or more of coagulants and flocculants such as, for example, GE's trade products KlarAid™ (organic and /or inorganic coagulants and specialty custom designed (blended) products), and PolyFloc™ and NOVUS™ high molecular weight organic flocculants (General Electric Company, Schenectady, N.Y.). The added chemicals may comprise one or more of activated carbon, inorganic iron and aluminum salts including ferric and ferrous chloride, ferric and ferrous sulfate, alum, polyaluminium chloride (PACl), and the like. The chemical may be added to the wastewater stream 202 in the primary stage at various locations. For example, the chemicals may be added to the stream of wastewater 202 upstream of a point where the TOCs are measured at the inlet of the flotation thickener 208. Optionally or alternatively, the chemicals may be added to the stream of wastewater downstream of a point where the TOCs are measured at the inlet of the flotation thickener 208. Also optionally or alternatively, the chemicals may be added in the flotation thickener 208. Optionally or alternatively, the chemicals may be added at the outlet of the flotation thickener 208.

Referring to FIGS. 2B and 2C, optionally or alternatively the chemicals may be added at a point that is upstream of a point where TOCs are measured at the outlet of the flotation thickener 208. Optionally or alternatively the chemicals may be added at a point that is downstream of a point where TOCs are measured at the outlet of the flotation thickener 208.

Referring to FIG. 2D, in one aspect the processing device 210 may be used to control one or more aspects of processing downstream 214 of the flotation thickener 208 based on the measured TOCs.

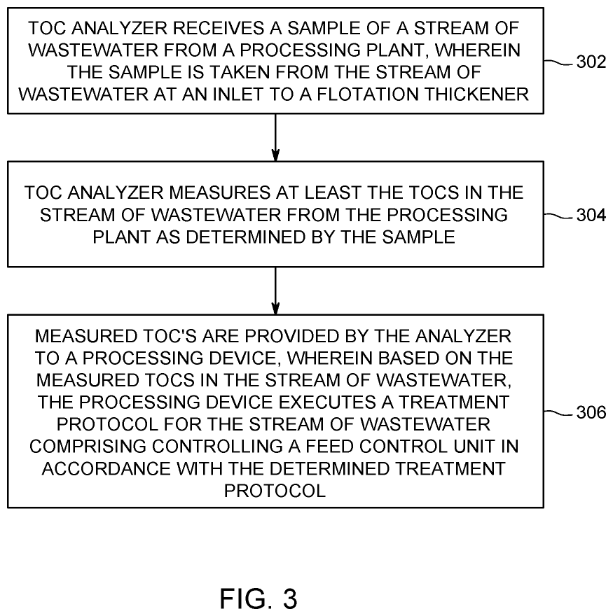

FIG. 3 is a flowchart that illustrates an exemplary method of treating wastewater using a total organic compound (TOC) analyzer. At step 302, the TOC analyzer receives a sample of a stream of wastewater from a processing plant, wherein the sample is taken from the stream of wastewater at an inlet to a flotation thickener. At step 304, the TOC analyzer measures at least the TOCs in the stream of wastewater from the processing plant as determined by the sample. At step 306, the measured TOC's are provided by the analyzer to a processing device, wherein based on the measured TOCs in the stream of wastewater, the processing device executes a treatment protocol for the stream of wastewater comprising controlling a feed control unit in accordance with the determined treatment protocol. As noted herein, the processing device may be integrated with and into the TOC analyzer or it may be separate from the TOC analyzer. Generally, treating the wastewater stream by controlling, by the processing device, the feed control unit in accordance with the determined treatment protocol comprises the feed control unit adding chemicals to the stream of wastewater. The added chemicals may comprise one or more of coagulants and flocculants, as described herein. The added chemicals may comprise one or more of activated carbon, inorganic iron and aluminum salts including ferric and ferrous chloride, ferric and ferrous sulfate, alum, polyaluminium chloride (PACl), and the like.

The chemicals may be added to the wastewater stream at various locations. For example, the chemicals may added to the stream of wastewater upstream of a point where the TOCs are measured at the inlet of the flotation thickener. Alternatively or optionally, the chemicals may be added to the stream of wastewater downstream of a point where the TOCs are measured at the inlet of the flotation thickener. Alternatively or optionally, the chemicals may be added in the flotation thickener. Alternatively or optionally, the chemicals may be added at the outlet of the flotation thickener.

Similarly, if the TOCs are monitored at the outlet of the flotation thickener, the chemicals may be added at a point that is upstream of a point where TOCs are measured at the outlet of the flotation thickener. Alternatively or optionally, the chemicals may be added at a point that is downstream of a point where TOCs are measured at the outlet of the flotation thickener

Though not shown in FIG. 3, the method may further include receiving, by the analyzer, a second sample from the stream of wastewater, wherein the second sample is obtained from an outlet of the flotation thickener, and measuring the TOCs of the second sample, wherein the measured TOCS provided to the processing device includes the TOCs measured at the inlet of the flotation thickener and the TOCs measured at the outlet of the flotation thickener. Optionally or alternatively, the method may include receiving, by the analyzer, a third sample from the stream of wastewater, wherein the third sample is obtained from in the flotation thickener, and measuring the TOCs of the third sample, wherein the measured TOCS provided to the processing device includes one or more of the TOCs measured at the inlet of the flotation thickener, the TOCs measured at the outlet of the flotation thickener, and the TOCs measured in the flotation thickener.

Alternatively or optionally, the method may further comprise controlling, by the processing device, one or more aspects of processing downstream of the flotation thickener based on the measured TOCs.

The system has been described above as comprised of units. One skilled in the art will appreciate that this is a functional description and that the respective functions can be performed by software, hardware, or a combination of software and hardware. A unit can be software, hardware, or a combination of software and hardware. The units can comprise software for treating wastewater. In one exemplary aspect, the units can comprise a processing device that comprises a processor 421 as illustrated in FIG. 4 and described below.

FIG. 4 illustrates an exemplary processing device 210 that can be used for treating wastewater. In various aspects, the processing device of FIG. 4 may comprise all or a portion of the analyzer 206 and/or a control system. As used herein, “processing device” may include a plurality of processing devices. The processing device 210 may include one or more hardware components such as, for example, a processor 421, a random access memory (RAM) module 422, a read-only memory (ROM) module 423, a storage 424, a database 425, one or more input/output (I/O) devices 426, and an interface 427. Alternatively and/or additionally, the processing device 210 may include one or more software components such as, for example, a computer-readable medium including computer executable instructions for performing a method associated with the exemplary embodiments. It is contemplated that one or more of the hardware components listed above may be implemented using software. For example, storage 424 may include a software partition associated with one or more other hardware components. It is understood that the components listed above are exemplary only and not intended to be limiting.

Processor 421 may include one or more processors, each configured to execute instructions and process data to perform one or more functions associated with a processing device for treating wastewater. Processor 421 may be communicatively coupled to RAM 422, ROM 423, storage 424, database 425, I/O devices 426, and interface 427. Processor 421 may be configured to execute sequences of computer program instructions to perform various processes. The computer program instructions may be loaded into RAM 422 for execution by processor 421.

RAM 422 and ROM 423 may each include one or more devices for storing information associated with operation of processor 421. For example, ROM 423 may include a memory device configured to access and store information associated with processing device 210, including information for identifying, initializing, and monitoring the operation of one or more components and subsystems. RAM 422 may include a memory device for storing data associated with one or more operations of processor 421. For example, ROM 423 may load instructions into RAM 422 for execution by processor 421.

Storage 424 may include any type of mass storage device configured to store information that processor 421 may need to perform processes consistent with the disclosed embodiments. For example, storage 424 may include one or more magnetic and/or optical disk devices, such as hard drives, CD-ROMs, DVD-ROMs, or any other type of mass media device.

Database 425 may include one or more software and/or hardware components that cooperate to store, organize, sort, filter, and/or arrange data used by processing device 210 and/or processor 421. For example, database 425 may store an algorithm for determining chemical dosage of the wastewater stream based on measured TOCs. Database may also store information associated with a method of treating wastewater using a total organic compound (TOC) analyzer comprising receiving, from an analyzer, measured TOCs for a wastewater stream from a processing plant, wherein the TOCs are measured by the analyzer in the stream of wastewater at an inlet to a flotation thickener; determine, based on the measured TOCs in the stream of wastewater, a treatment protocol for the stream of wastewater; and treating the wastewater stream by controlling a feed control unit in accordance with the determined treatment protocol. It is contemplated that database 425 may store additional and/or different information than that listed above.

I/O devices 426 may include one or more components configured to communicate information with a user associated with processing device 210. For example, I/O devices may include a console with an integrated keyboard and mouse to allow a user to maintain an algorithm for determining chemical dosage of the wastewater stream based on measured TOCs, software for treating wastewater using a total organic compound (TOC) analyzer, and the like. I/O devices 426 may also include a display including a graphical user interface (GUI) for outputting information on a monitor. I/O devices 426 may also include peripheral devices such as, for example, a printer for printing information associated with processing device 210, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 427 may include one or more components configured to transmit and receive data via a communication network, such as the Internet, a local area network, a workstation peer-to-peer network, a direct link network, a wireless network, or any other suitable communication platform. For example, interface 427 may include one or more modulators, demodulators, multiplexers, demultiplexers, network communication devices, wireless devices, antennas, modems, and any other type of device configured to enable data communication via a communication network.

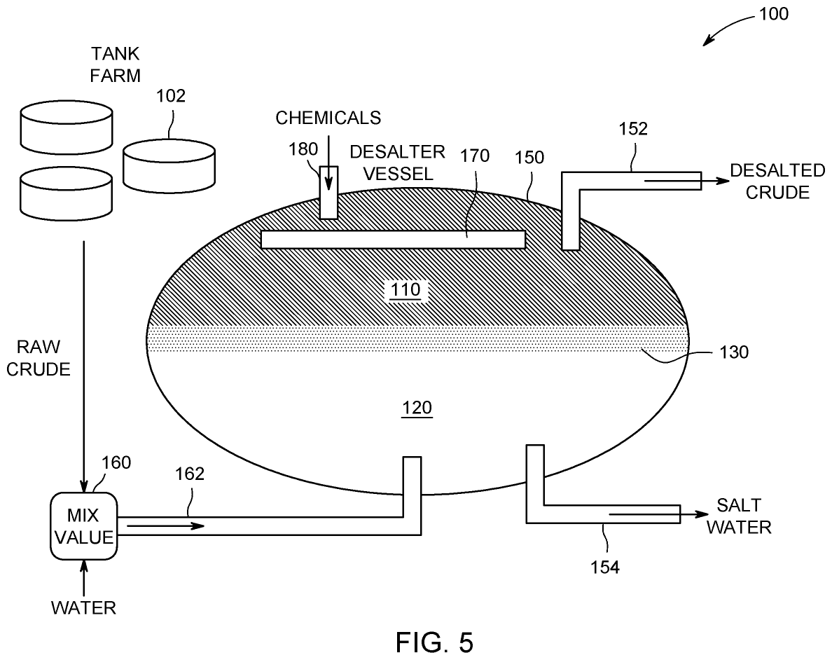

As noted above, at least a portion of the wastewater stream 202 that flows from the processing plant 204 may be effluent from a desalter. FIG. 5 is a block schematic diagram of a desalter system 100 that can be used in a refining process, in accordance with some embodiments. The system includes a desalter vessel 150 that receives a combination of raw crude oil (e.g., from a tank farm 102) and water from a mix valve 160 via an input pipe 162. The desalter vessel 150 provides desalted crude oil via a first output pipe 152 and salt water or brine via a second output pipe 154. This salt water or brine can comprise the effluent that forms the wastewater stream 202. A chemical input pipe 180 and/or an electrified grid 170 may facilitate separation within the desalter vessel 150 of an oil region 110 and a water region 120 that interface at a rag layer 130. The geometry of the vessel 150 and associated pipes 162, 152, 154, 180, the chemicals injected into the vessel, the power applied to the electrified grid may all impact operation of the system.

The organic carbon content of the petroleum refinery desalter brine water can be measured using an online Total Organic Carbon (TOC) analyzer, such as those described herein. In some instances, TOCs may be measured at the inlet 162 and/or the outlet 154 of the desalter. In some instances, effluent from the desalter outlet 154 may flow to a gravity separator (also known as a gravity/API separator, where API stands for American Petroleum Institute). Generally, the gravity separator is downstream of the desalter and upstream of the floatation thickener. TOCs may be measured at the inlet and/or the outlet of the gravity separator. The measurement data obtained by the TOC analyzer can be used to monitor, control and optimize the performance of a petroleum refinery desalter process unit 100. The data from the TOC online analyzer is used to monitor the desalter brine water stream for the presence of organic compounds. The data from the online analyzer can then sent to a Supervisory Control and Data Acquisition (SCADA) system and/or associated Distributed Control Systems (DCS), Programmable Logic Controllers (PLC) or Human Machine Interface (HMI). Upstream process chemical injection systems are then controlled using an algorithm that considers the TOC of the desalter brine water.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method of treating wastewater comprising:
measuring, using an analyzer, at least total organic carbons (TOCs) in a stream of wastewater comprised of petroleum refinery desalter brine water;
providing, by the analyzer, the measured TOCs to a processing device;
determining, by the processing device, based on the measured TOCs in the stream of wastewater, a treatment protocol for the stream of wastewater; and
treating the wastewater stream by controlling, by the processing device, a feed control unit in accordance with the determined treatment protocol.

2. The method of claim 1, wherein treating the wastewater stream by controlling, by the processing device, the feed control unit in accordance with the determined treatment protocol comprises the feed control unit adding chemicals to the stream of wastewater, said added chemicals comprising one or more of coagulants and flocculants including one or more of activated carbon, inorganic iron and aluminum salts including ferric and ferrous chloride, ferric and ferrous sulfate, alum, and polyaluminium chloride (PACl).

3. The method of claim 2, wherein the chemicals are added to the stream of wastewater upstream of a point where the TOCs are measured, downstream of a point where the TOCs are measured, or in a desalter that produces at least a portion of the desalter brine water.

4. The method of claim 3, wherein the TOCs are measured at an inlet and/or at an outlet of the desalter or at an inlet and/or at an outlet of a gravity separator.

5. The method of claim 3, further comprising controlling, by the processing device, one or more aspects of the desalter based on the measured TOCs.

6. A system for treating wastewater comprised of:
a desalter;
an analyzer, wherein the analyzer measures at least total organic carbons (TOC) in a stream of wastewater comprised of petroleum refinery desalter brine water; and
a processing device in communication with the analyzer and a feed control unit, wherein the processing device:
receives the measured TOCs from the analyzer;
determines, based on the measured TOCs in the stream of wastewater, a treatment protocol for the stream of wastewater; and
treats the wastewater stream by controlling the feed control unit in accordance with the determined treatment protocol.

7. The system of claim 6, wherein treating the wastewater stream by controlling, by the processing device, the feed control unit in accordance with the determined treatment protocol comprises the processing device causing the feed control unit to add chemicals to the stream of wastewater, said added chemicals comprise one or more of coagulants and flocculants including one or more of activated carbon, inorganic iron and aluminum salts including ferric and ferrous chloride, ferric and ferrous sulfate, alum, and polyaluminium chloride (PACl).

8. The system of claim 7, wherein the chemicals are added to the stream of wastewater upstream of a point where the TOCs are measured, downstream of a point where the TOCs are measured, or added in the desalter.

9. The system of claim 6, wherein the TOCs are measured at an inlet and/or at an outlet of the desalter or at an inlet and/or at an outlet of a gravity separator.

10. The system of claim 6, further comprising one or more downstream processing devices, wherein the desalter or at least one of the one or more downstream processing devices are controlled by the processing device based on the measured TOCs.

11. A method of treating wastewater using a total organic carbon (TOC) analyzer comprising:
receiving, by the TOC analyzer, a sample of a stream of wastewater from a processing plant, wherein the wastewater is comprised of petroleum refinery desalter brine water;
measuring, by the TOC analyzer, at least TOCs in the stream of wastewater from the processing plant as determined by the sample; and
providing, by the analyzer, the measured TOC's to a processing device, wherein based on the measured TOCs in the stream of wastewater, the processing device executes a treatment protocol for the stream of wastewater comprising controlling a feed control unit in accordance with the determined treatment protocol.

12. The method of claim 11, wherein the processing device is integrated with and into the TOC analyzer.

13. The method of claim 11, wherein the processing device is separate from the TOC analyzer.

14. The method of claim 13, wherein the processing device comprises a programmable logic controller (PLC), a computer, or a field-programmable gate array (FPGA).

15. The method of claim 11, wherein treating the wastewater stream by controlling, by the processing device, the feed control unit in accordance with the determined treatment protocol comprises the feed control unit adding chemicals to the stream of wastewater, said added chemicals comprising one or more of coagulants and flocculants including one or more of activated carbon, inorganic iron and aluminum salts including ferric and ferrous chloride, ferric and ferrous sulfate, alum, and polyaluminium chloride (PACl).

16. The method of claim 15, wherein the chemicals are added to the stream of wastewater upstream of a point where the TOCs are measured, downstream of a point where the TOCs are measured, or added in a desalter that produces at least a portion of the desalter brine water.

17. The method of claim 16, wherein the TOCs are measured at an inlet and/or at an outlet of the desalter or at an inlet and/or at an outlet of a gravity separator.

18. The method of claim 16, further comprising controlling, by the processing device, one or more aspects of the desalter based on the measured TOCs.

19. A non-transitory computer program product comprising computer-executable code sections for executing by a processor, said computer-executable code sections causing the processor to:
receive, from an analyzer, measured TOCs for a wastewater stream comprised of petroleum refinery desalter brine water;
determine, based on the measured TOCs in the stream of wastewater, a treatment protocol for the stream of wastewater; and
treat the wastewater stream by controlling a feed control unit in accordance with the determined treatment protocol.

20. The computer program product of claim 19, wherein treating the wastewater stream by controlling the feed control unit in accordance with the determined treatment protocol comprises the feed control unit adding chemicals to the stream of wastewater.

21. The computer program product of claim 19, wherein the TOCs are measured at an inlet and/or at an outlet of a desalter.

22. The computer program product of claim 19, wherein the TOCs are measured at an inlet and/or at an outlet of a gravity separator.
